(19) United States
(12) Patent Application Publication
(10) Pub. No.: US 2007/0030791 A1
(43) Pub. Date: Feb. 8, 2007

(54) Probe memory device and positioning method therefor

(75) Inventors: Takehiko Hasebe, Yokohama (JP); Yasushi Goto, Kokubunji (JP); Kiyoko Yamanaka, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/483,093

(22) Filed: Jul. 10, 2006

(30) Foreign Application Priority Data
Aug. 5, 2005 (JP) 2005-228319

(51) Int. Cl. G11B 9/00

(52) U.S. Cl. 369/126

(57) ABSTRACT

In a probe memory device, a technique of realizing consistency of high-density recording and high-speed reading/writing is provided. A recording medium is placed to a probe array chip on which a plurality of probes are arranged in such a way as to maintain a constant spacing thereto by adopting a high-stiffness elastic support structure. The recording medium is equipped with a stage scanner that is driven continuously while drawing a constant trajectory on an X-Y plane almost in parallel to a probe array chip plane. The probes are equipped with respective actuators each being driven in a Z direction almost perpendicular to the X-Y plane. Each of the probes is made to write or read by altering a distance between the probe and the recording medium in parallel processing. The X-Y actuator is controlled so that the probe may continue a predetermined cyclic movement. Moreover, a tracking area is provided in a portion of the recording medium, and a trajectory of the probe by actuation is controlled so as to have a fixed geometry.

### CLAIM OF PRIORITY

The present application claims priority from Japanese application JP 2005-228319 filed on Aug. 5, 2005, the content of which is hereby incorporated by reference into this application.

### FIELD OF THE INVENTION

This invention relates to a probe memory device and a positioning method therefor, and more specifically to an effective technique applied to X-Y stage scanner actuation that is used for an information recording device capable of writing or reading a large volume of electronic data with ultra-high density.

### BACKGROUND OF THE INVENTION

As a technique that this inventor examined, for example, the following technique is conceivable in the probe memory device.

The probe memory technique of using the principle of the scanning probe microscope is being expected as a recording method for increasing recording density. This technique is implemented with a recording medium, an actuator that places the recording medium on a stage scanner and actuates it in X-Y directions, a probe equipped with one or more probe tip of a very small size for performing writing/reading information on and from the recording medium, and a signal processor for properly processing the information and outputting desired data. The probe tip is brought closer to or into contact with a desired position of the recording medium, and is allowed to detect various physical quantities on the recording medium at spatial resolution of an atom or molecule level, whereby reading or writing information is performed. Therefore, the implementation needs a high-accuracy X-Y actuator capable of being driven in two axes of X and Y directions or more. Moreover, a probing actuating unit that moves the probe in the Z direction in synchronization with the recording medium moving on an X-Y plane and brings the probe tip closer to or into contact with the recording medium becomes necessary.

As described in “IEEE Transactions on Nanotechnology” (published in United States), Vol. 1, pp. 39-55 (2002) or U.S. Pat. No. 5,835,477, a method of performing information recording by pressing a probe tip heated to a fixed temperature on a recording medium made of a resin material and forming a minute dent thereon.

In this method, a probe array chip in which a large number of probes each having a probe tip thereon are arranged is opposed to the recording medium, a multi-axis electromagnetic actuator using interaction between coils and magnets actuates the recording medium, whereby each probe tip is enabled to record information in an area with a certain fixed area (recording bit) of the recording medium, and at the same time the each probe tip can perform recording in the corresponding recording bit in parallel processing. In this technique, consequently improvement in data transfer speed by parallel processing and improvement in recording density by miniaturization of the probe structure are also expectable.

In addition, as described in U.S. Pat. No. 6,735,163, there has been devised a method of writing or reading information intact with the use of a field emission source and a recording medium. In this method, the field emission source and a recording medium on the X-Y actuator are disposed being opposed to each other, and an electron beam is irradiated on the recording medium to write or read information. The irradiation of electron beam features a high operation speed and easy control of an irradiated position by a circular gate. Moreover, in the X-Y actuator that supports a recording medium with beams, their beams are deformed by an acting force given by a know method, such as an electrostatic method, an electromagnetic method, and a piezoelectric method, which moves the recording medium in the X or Y direction. By combining controls of the electron beam irradiated position and the X-Y actuator, the electron beam scans the recording medium so as to draw thereon a Lissajous figure (a triangular-wave shape, a saw-tooth wave profile, an omega curve, and multiple frequency omega curve).

### SUMMARY OF THE INVENTION

Here, the inventors of this invention examined a technique of the probe memory device as described above and made clear the following.

For example, it is necessary for the probe memory system to move tips of one or more probes (hereinafter referred to as “probe tip”) to reading/writing positions of a recording medium on the X-Y actuator, bring the probe tips closer to or into contact with the recording medium by Z-actuation of the probe, and elevate the probe tips. In this operation, it is desirable to halt the X-Y actuator during probing, such as z actuation of probe tip and reading/writing in sequence of reading/writing data. A complex control of parameters of the X-Y actuator is required in order to move a stage scanner of a recording medium size comparable in dimensions to a semiconductor memory and a hard disk and halt it, i.e., to drive a stage scanner of millimeter units to centimeter units in accuracy of nanometer.

Moreover, in the case where a stage scanner as described in “IEEE Transactions on Nanotechnology,” Vol. 1, pp. 39-55 (2002) and U.S. Pat. No. 5,835,477 described above is fixed with an elastic support and its position is controlled by a driver element using an acting force (for example, an electrostatic driven force, an electromagnetic driven force, a piezoelectric driven force, or the like), It takes a long time from an input of a control signal to braking of the elastic support, to achieve a good balance between high-speed reading/writing data and high recording density. With respect to these problems, the above-mentioned conventional technique does not provide concrete description regarding each driving process. In addition, the above-mentioned conventional technique comes with the following problems.

In the case of the conventional technique as described in “IEEE Transactions on Nanotechnology,” Vol. 1, pp. 39-55 (2002) or U.S. Pat. No. 5,835,477, in order to secure positioning accuracy of a recording medium driven by the actuator, a column made of a flexible resin is used for the elastic support of the recording medium. Therefore, the resign acts as a damper when the recording medium is being driven. Consequently a resonance frequency decreases and a driving speed of the recording medium (stage scanner) falls. As a result, it takes a time for an individual probe to move between memory areas, which poses a limit of improvement of the data transfer speed. As a resolution measure to the limit, this conventional example devises a measure to improves the data transfer speed by using multi-probe parallel processing that uses a probe array chip structure in which a large number of probes each having the probe tip are arranged and integrated in very large scale. However, as a result, the probe array chip becomes required to install a large number of signal lines and switches, which will cause new problems, such as attenuation of a high-frequency signal due to electrostatic capacity among signal lines and bit loss due to a limit of manufacture yield.

FIG. 17 shows an outline configuration of the actuator according to this conventional method. The upper part of FIG. 17 is a plan view and the lower part thereof is a sectional view taken along the cutting plane C-C′. In FIG. 17, the reference numeral 1301 denotes a base frame, 1302 a platform, 1303 a suspension arm, 1304 patterned coils, 1305 and 1306 permanent magnets, and 1307 magnetic lines of force.

Moreover, in the case of the conventional technique described in U.S. Pat. No. 6,735,163, since the electron beam is used, a space in which the field emission source and the recording medium are placed must be maintained under a high vacuum. Furthermore, since a circular gate for controlling a direction of an electron beam from a field emission source becomes necessary additionally, it is difficult to arrange the field emission sources densely. In order that the trajectory of an electron beam draws a triangle waveform, a saw-tooth waveform, an omega curve, and a multi-frequency omega curve, a control of a circular gate to which an operation of the X-Y actuator is fed back becomes necessary, and then a complex control circuit for temporally controlling the amplitude and the angular frequency becomes necessary. Meanwhile, although U.S. Pat. No. 6,735,163 explicitly indicates a recording method of recording data while the probe moves mainly in one direction drawing such a trajectory, there is no concrete description about a technique of reading the information.

FIGS. 18A and 18B show an outline construction of the actuator by this conventional method. The upper part of FIG. 18A is a plan view and the lower part thereof is a sectional view taken along the cutting plane D-D′. FIG. 18B is a figure showing a trajectory of an electron beam. In FIGS. 18A and 18B, the reference numeral 1401 denotes a packaging case, 1402 a frame, 1403 a beam, 1404 a recording medium, 1405 a storage area, 1406 a field emission source, 1407 a circular gate, and 1408 a trajectory of an electron beam.

In view of this, the objective of this invention is to provide a technique of realizing consistency between high-density recording and high-speed reading/writing in a probe memory device.

The above-mentioned and other objects and novel features of this invention will become clear by description of this specification and the attached drawings.

Among inventions that will be disclosed in this specification, representative inventions will be described briefly as follows.

The above-mentioned problem can be effectively solved by actuating a stage scanner provided to a recording medium member continuously with excellent accuracy so that it may draw a constant trajectory repeatedly. Specifically, the following measures are taken.

That is, the probe memory device by this invention shall be configured to write/read information on or from an recording medium placed in an X-Y actuator in parallel processing by bringing a plurality of probe tips closer to or into contact with the medium. A high-stiffness elastic beams support the recording medium so that the recording medium may maintain a constant spacing to a probe array chip in which a plurality of probes including the probe tips are arranged. The recording medium is placed in the stage scanner that is continuously driven while drawing a constant trajectory on an X-Y plane almost parallel to a probe array chip plane. Each probe is equipped with an actuator that drives the probe in a direction almost perpendicular to the X-Y plane (so-called a Z direction) and a spacing between the probe tip and the recording medium is varied in parallel processing. The X-Y actuator is controlled so that the stage scanner may always draw a constant trajectory repeatedly. Moreover, a tracking area is provided in a section of the recording medium.

By the above, the simple system can attain high reliability and lower costs simultaneously. Moreover, with adoption of the multi-probe array it become possible to improve the data transfer speed.

It is effective for miniaturization of dimensions of a probe memory system to adopt an electromagnetic driven or electrostatic driven actuator as an actuator capable of driving the recording medium in two directions on the X-Y plane. In order to optimize the probe memory system, it was determined that the X-Y actuation exerted continuous movement that did not perform a halt control, and that recording positions of the recording medium were arranged in accordance with driving of the stage scanner. The continuous movement of X-Y actuation shall be continuous X-Y actuation such that the probe tip may draw a Lissajous figure on the recording medium.

Here, a Lissajous figure means a two-dimensional trajectory that an intersection of simple oscillations of the X axis and of the Y axis that are expressed, respectively, by:
X=Ax·cos(ωx·t+φx)
Y=Ay·sin(ωy·t+φy).

Each parameter denotes as follows:
Ax: amplitude of simple oscillation in the X direction
ωx: angular frequency of simple oscillation in the X direction
φx: phase of simple oscillation in the X direction
Ay: amplitude of simple oscillation in the Y direction
ωy: angular frequency of simple oscillation in the Y direction
φy: phase of simple oscillation in the Y direction
t: time

The Z-axis actuation of the probe tip, i.e., probing is done in synchronization with the X-Y actuation. Especially, in the case where the probing is done at a constant frequency, its control system can be simplified. In this case, since the driving speed becomes slow in a position of maximum driving length (hereinafter described as the periphery) of X-Y actuation, a travelling shift between the probing with the probe tips becomes extremely small. Therefore, although depending on how to record information on the recording medium, it is likely that the travelling shift falls below scanning resolution of the probe, and accordingly this peripheral area is unsuitable as a recording medium section to read/write data. To circumvent this, intrinsic recording information has been inputted beforehand in the periphery of X-Y actuation, and position shift is detected by reading this information. Based on detected results, parameters (Ax, ωx, φx, Ay, ωy, φy, etc.) for controlling currents to the patterned coils of X-Y actuation are controlled in the electromagnetic actuator, if needed, so that the driving may become a continuous driving along a predetermined Lissajous figure.

The central section of the recording medium shall be an information recording medium area. Moreover, since when the frequency of probing is varied in synchronization with the X-Y actuation, the interval of the position of recording by the probing can be set up freely; therefore, the recording density can be further improved.

Note that in the driving and controlling method according to this invention, a recording method using a probe is not restricted to the described above. The recording method may be a method in which a phase change phenomenon of a recording bit through a probe tip is used. As this example, there can be exemplified a method using a magnetization reversal phenomenon by current injection, a method using a ferroelectric material, and the like. Moreover, a method in which a polymer layer is used as the recording bit and a minute hole is formed or detected by contact of a probe tip and the like are exemplified.

Effects attained by representative inventions among the inventions disclosed in this specification can be summarized as follows.
(1) There can be provided cheaply a large-scale memory recording device in which stable driving of the X-Y actuator and reading/writing of data are enabled with the small-scale control circuit.
(2) Since a high-stiffness material is used for the elastic support for fixing the recording medium member, it becomes possible to increase a driving frequency of the actuator and shorten a travelling time between individual recording bits; therefor, the operation speed can be speeded up.
(3) By adopting an electrostatic driven or electromagnetic driven actuator, it becomes possible to miniaturize dimensions of a positioning mechanism and make dimensions of the whole recording device small.

### BRIEF DESCRIPTION OF THE DRAWINGS

FIG. 1 is a sectional view showing a configuration of a probe memory device according to a first embodiment of this invention;

FIG. 2 is a sectional view showing a structure of an X-Y electromagnetic actuator in the probe memory device according to the first embodiment of this invention;

FIG. 3 is a plan view showing the structure of the X-Y electromagnetic actuator in the probe memory device according to the first embodiment of this invention;

FIG. 4 is a sectional view showing structures of a recording bit and a probe in the probe memory device according to the first embodiment of this invention;

FIG. 5 is a perspective view showing a configuration of the recording medium and the probe array chip in the probe memory device according to the first embodiment of this invention;

FIGS. 6A to 6G are sectional views showing a method for manufacturing a stage scanner and patterned coils of the X-Y electromagnetic actuator in the probe memory device according to the first embodiment of this invention;

FIG. 7 is a block diagram showing a system configuration and operations of the probe memory device according to the first embodiment of this invention;

FIGS. 8A and 8B are diagrams showing a signal to the patterned coil, a displacement of the stage scanner, and a timing of reading/writing of the data signal, respectively, versus time;

FIGS. 9A and 9B are diagrams showing positions of the recording bits on the stage scanner in the probe memory device according to the first embodiment of this invention;

FIGS. 10A to 10E are diagrams showing several variations of the driving signal into the patterned coil in the probe memory device according to the first embodiment of this invention;

FIGS. 11A to 11D are views showing a configuration of the electrostatic actuator in the probe memory device according to a second embodiment of this invention;

FIG. 12 is a view showing a variation of the beams in the probe memory device according to a third embodiment of this invention;

FIG. 13A is a plan view showing an arrangement of the recording bits in the stage scanner carrying the recording medium of the actuator in the probe memory device according to a fourth embodiment of this invention, and FIG. 13B is a plan view showing an arrangement of the recording bits in an effective recording area (b);

FIGS. 14C and 14D are plan views showing arrangements of the recording bits in effective recording areas (c) and (d), respectively, in the probe memory device according to the fourth embodiment of this invention;

FIGS. 15E and 15F are plan views showing arrangements of the recording bits in effective recording areas (e) and (f), respectively, in the probe memory device according to the fourth embodiment of this invention;

FIG. 16 is a plan view showing an arrangement of the recording bits in effective recording area (f) in the probe memory device according to the fifth embodiment of this invention;

FIG. 17 is a view showing a structure of an actuator according to the conventional method in the probe memory device that was examined as a premise of this invention; and

FIG. 18A is a view showing the structure of the actuator according to the conventional method in the probe memory device that was examined as a premise of this invention, and FIG. 18B is a view showing a trajectory of an electron beam in the actuator.

### DETAILED DESCRIPTION OF THE PREFERRED EMBODIMENTS

Hereafter, embodiments of this invention will be described in detail with reference to the drawings. Note that in all the drawings for illustrating embodiments, the same member is designated by the same reference numeral and symbol and repeated explanation therefor will be omitted.

### First Embodiment

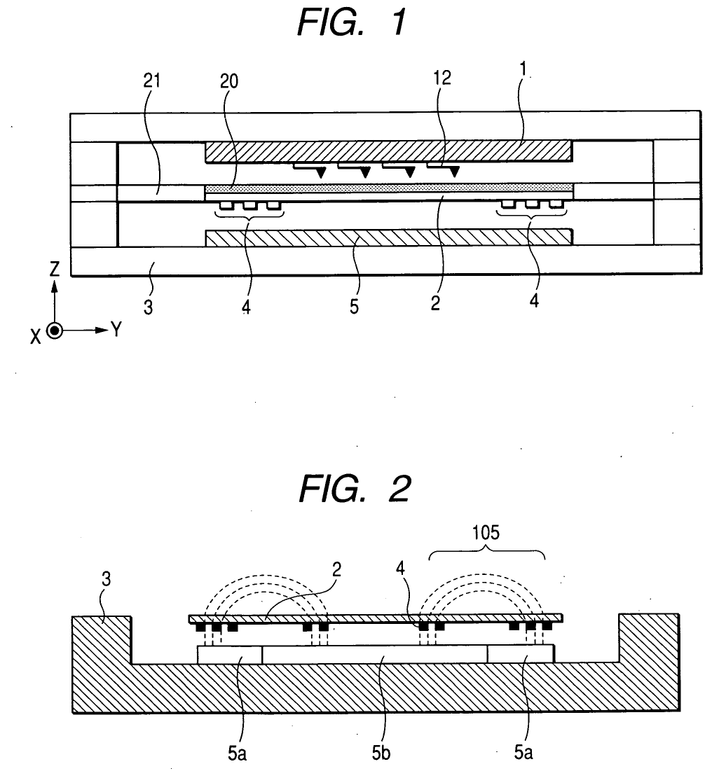

FIG. 1 is a sectional view showing a structure of a probe memory device using an X-Y electromagnetic actuator according to a first embodiment of this invention.

First, one example of a structure of the probe memory device according to this embodiment will be explained with reference to FIG. 1. The probe memory device of this first embodiment consists of, for example, a probe array chip 1, a stage scanner 2, a package 3, patterned coils 4, permanent magnets 5, a plurality of probes 12, a recording medium 20, a beam 21, etc.

The probe array chip 1 on which the probe 12 is fixed to a stationary system, like as package 3. The inventors adopt an arrangement in which each of the probes 12 provided in the probe array chip 1 is driven individually in the Z direction, and the stage scanner 2 carrying the recording medium 20 is driven in X and Y directions by the X-Y electromagnetic actuator. The high-stiffness elastic support structure supports the stage scanner 2 carrying the recording medium 20 so that the recording medium may maintain a constant spacing to the probe array chip 1. For example, the stage scanner 2 is supported by the beams 21 and arranged to be movable in the X and Y directions. A driving mechanism (X-Y electromagnetic actuator) for driving the stage scanner 2 in the X and Y directions consists of the patterned coils 4 on the rear side of the stage scanner 2 and the permanent magnets 5 fixed to the package 3.

FIG. 2 is a sectional view showing a structure of the X-Y electromagnetic actuator consisting of the patterned coils 4 mounted on the rear side of the stage scanner 2 and the permanent magnets 5 (5a, 5b) fixed to the package 3. The structure shown in the figure is to illustrate driving to the right-left direction to the figure. The permanent magnets 5a, 5b are arranged in the package 3. The permanent magnet 5a and the permanent magnet 5b shall have mutually different magnetic poles in a plane opposed to the patterned coils 4. The stage scanner 2 having the patterned coils 4 is installed so as not to make a contact with this. At this time, directions of vertical components of magnetic lines of flux 105 from the permanent magnets 5a, 5b are set to be reversed at a boundary defined by the center of the inside of the patterned coils 4.

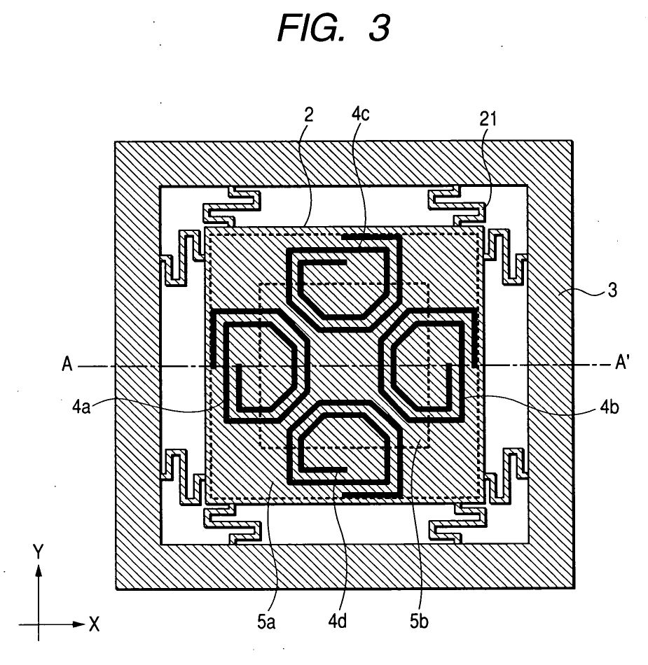

FIG. 3 is a plan view showing a structure of the X-Y electromagnetic actuator that is made of the patterned coils 4 (4a, 4b, 4c, and 4d) installed on the rear side of the stage scanner 2 shown in FIG. 2 and the permanent magnets 5a, 5b fixed to the package 3. FIG. 2 corresponds to a cross section taken along the cutting plane A-A′ of FIG. 3.

Positional relation of the patterned coils 4a, 4b, 4c, and 4d and a method for driving and controlling the X-Y electromagnetic actuator will be explained. The patterned coils 4a, 4b, 4c, and 4d are arranged on the rear side of the stage scanner 2 carrying the recording medium 20, and the stage scanner 2 is fixed to the package 3 with the beams 21. The patterned coils 4a and 4b act driving in the horizontal direction (X direction) and the patterned coils 4c and 4d act driving in the vertical direction, respectively. Each of the permanent magnets 5a and 5b has a structure such that the N poles and the S poles are reversed to their driving direction at a boundary defined by the center of the electromagnetic coil. The permanent magnetic 5a and the permanent magnet 5b indicate mutually reverse magnetic poles.

Details of the driving method will be explained about the X direction below. By energizing the patterned coils 4a, 4b in the magnetic field by the permanent magnets 5, Lorentz force by the magnetic field and the current is generated. Since the permanent magnets 5 have been arranged so that their N poles and S poles may be reversed to the drive direction at the center of the patterned coils 4a, 4b, the Lorentz force acts on right and left signal lines in coils, to the same orientation in the X direction. Moreover, if the directions of the currents of the patterned coil 4a and the patterned coil 4b are set mutually reverse, the Lorentz forces generated in the both patterned coils will act in the same orientation. By flowing an alternating current in the patterned coils, the direction of the Lorentz force is reversed temporally and the stage scanner 2 reciprocates. Driving in the Y direction is done in the same way. The X-Y electromagnetic actuator has an action of being moved by a resultant force of the Lorentz force and a elastic force of the beams 21.

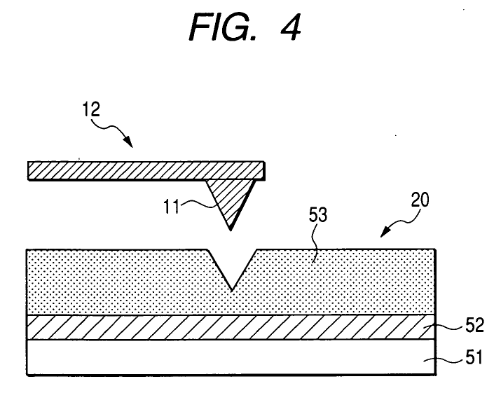

Although there are several methods for performing reading/writing of information, in this embodiment, the same method as described in “IEEE Transactions on Nanotechnology,” Vol. 1, pp. 39-55 (2002) or U.S. Pat. No. 5,835,477 can be used. FIG. 4 is sectional view showing a structure of the recording medium 20 and a structure of the probe 12. The recording medium 20 shall be one such that a resistive heater whose temperature rises by being energized is formed on a SiO₂ film on a surface of a Si wafer and a polymer layer 53 is thereon formed. Recording of information is performed by contacting a probe tip 11 formed at a tip of the probe 12 with the polymer layer 53 on the surface of the recording medium and forming a micro hole. Moreover, reading of information is preformed by measuring a shape with the probe tip 11 to recognize presence of the micro hole or its shape. The temperature of the polymer layer 53 is raised until exceeding the glass transition temperature by energizing a resistive heater 52 to smooth the polymer layer 53, whereby collective erasing of information (formatting) is done. In addition to this, there is a method in which phase change by current injection from the probe tip is used as an utilizable recording method, and the method is not restricted to these methods.

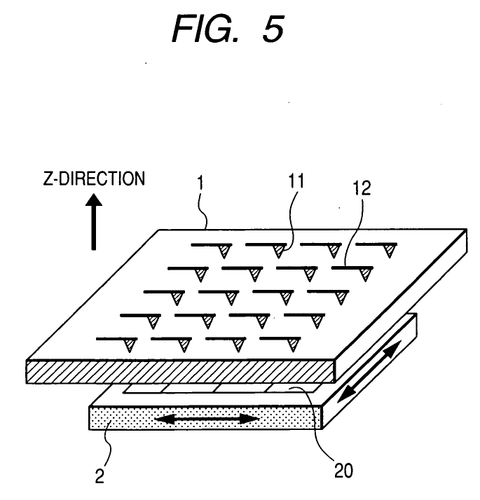

FIG. 5 is a perspective view showing a structure of the recording medium 20 and a structure of the probe array chip 1. The probe array chip 1 consists of the plurality of probes 12 arranged in the X and Y directions. A large number of recording bits are arranged in a plane of the recording medium 20 on the stage scanner 2. The probe array chip land the recording medium 20 are arranged being opposed to each other, and the probe tip 11 provided on the each probe 12 is brought closer to or into contact with the recording bit on the recording medium 20 to perform reading/writing of information. The probe array is so configured that an data storaging instruction is transferred to each probe tip 11 independently if needed, whereby high-speed data transfer becomes possible in parallel processing.

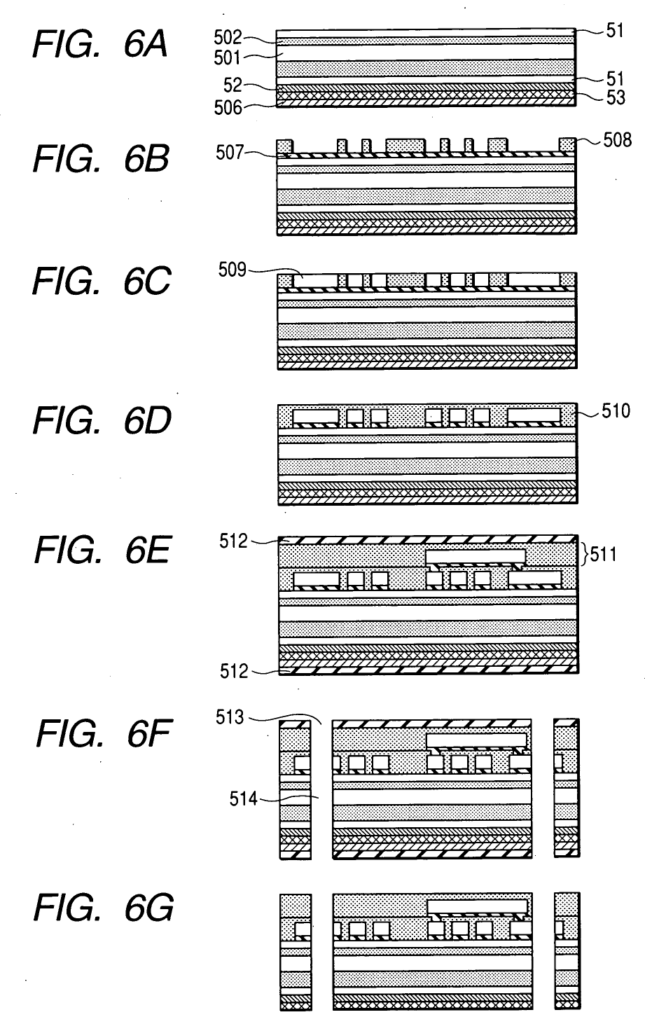

Next, with reference to FIG. 6, a method for manufacturing the recording medium 20, the stage scanner 2, and the patterned coils 4 installed on the rear side of the stage scanner 2 that constitute the probe memory device according to this first embodiment will be explained.

First, a thermally oxidizing process of an SOI (Silicon on Insulator) wafer including therein a SiO₂ layer 501 forms a SiO₂ layer 51 on the surface of a Si layer 502. On the one side of the wafer, the resistive heater 52, the polymer layer 53, and a protection film 506 are formed, and this side shall be served as a recording medium surface (the recording medium 20, the stage scanner 2) (FIG. 6A).

The patterned coil 4 is formed on the other side of the wafer as follows. For example, after laminating a chromium film and a copper film serially by spattering to form a metal layer 507, a photo resist is formed excluding portions where the patterned coil 4 and an extraction signal line from the patterned coil 4 are to be formed.

Next, portions that will be the electromagnetic coil 4 and signal lines on the support frame are formed by precipitating low-resistance metal 509, such as copper, by electroplating, and an end of the signal line outside the patterned coil 4 and the signal line on the base frame are connected with the extraction signal line on the beams 21 (FIG. 6C).

By removing the photo resist and etching the conducting film, the patterned coil 4 is manufactured, and an insulator 510, such as a polyimide film, is formed to protect the coil 4 (FIG. 6D).

Repeating the signal line formation process, a signal line 511 that connects an end of the signal line in the center 4 of the patterned coil and the extraction signal line outside the coil is formed. Aluminum films 512 are formed on the coil plane and the recording medium surface (FIG. 6E).

After forming a space pattern 513 in the recording medium surface by the photolithography of a photo resist and etching of an aluminum film, a polyimide film of the space pattern, a recording layer, a conductive-layer, a Si layer, and a SiO₂ film are etched by etching with different etching substances, and a space pattarn 514 is opened in the periphery of the actuator except the beams 21 (FIG. 6F).

Removing the aluminum films 512 and the process protective film 506, manufacture of the recording medium 20, the stage scanner 2, and the patterned coil 4 is completed (FIG. 6G).

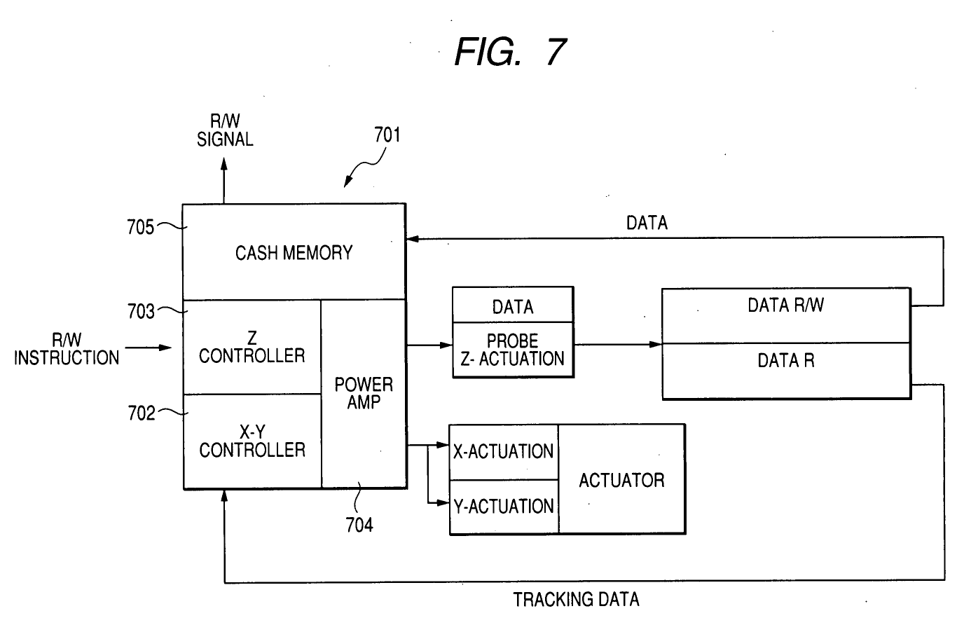

Next, with reference to FIG. 7, a system configuration of a probe memory device according to this first embodiment will be explained. FIG. 7 is a diagram showing the system configuration of the probe memory device according to this first embodiment and its operation.

As shown in FIG. 7, a control circuit 701 mainly consists of: an X-Y controller 702 for controlling movement of the stage scanner 2 on which a recording medium is mounted; a Z controller 703 for controlling driving in the Z direction of the probe 12 for reading/writing data from/on recording bits; a power AMP 704 for amplifying a control signal of a controller; and cache memory 705 for temporarily storing data that is read/written to or from each recording bit on the recording medium. Moreover, the recording medium 20 has a position detection processing mechanism for detecting a position of probing accurately in a section thereof, and corrects the position of probing by performing a control with the X-Y controller 702 based on the signal. When a writing instruction of writing data was inputted into the control circuit 701, the X-Y controller 702 energizes the patterned coil for driving in the X and Y directions through the power AMP 704 and drives the stage scanner 2. When the stage scanner 2 reached a requested position of the recording medium that accompanied the writing instruction, the Z controller 703 drives the probe 12 in the Z direction through the power AMP 704 and the probe 12 transfers the data signal to be written to the recording bit. A recording bit stores data nonvolatilely.

Moreover, when a reading instruction of reading data was inputted to the control circuit 701, the X-Y controller 702 energizes the patterned coil for driving in the X and Y directions through the power AMP 704 and drives the stage scanner 2. When the stage scanner 2 reached a requested position of the recording medium that accompanied the reading instruction, the Z controller drives the probe 12 in the Z direction through the power AMP 704 and the probe 12 reads the data signal from the recording bit. The data signal is temporarily stored in cache memory 705 area in the control circuit 701, and subsequently outputted to the outside of the control circuit 701 as the data signal.

When the position of the probe 12 reached the recording medium area used for detecting information for position correction (hereinafter referred to as the tracking data detection area), the probe 12 detects the probing position by itself by reading preset data inherent to the periphery of the recording medium by probing, feeds back parameters of amplitude, angular frequency, phase, etc. required to correct the X-Y electromagnetic actuator to the X-Y controller 702, which makes the X-Y actuation proper. By performing such detection of accuracy of position each time the position of the probe reaches a tracking data detection area of the recording medium, high accuracy of position of the probing is always maintained.

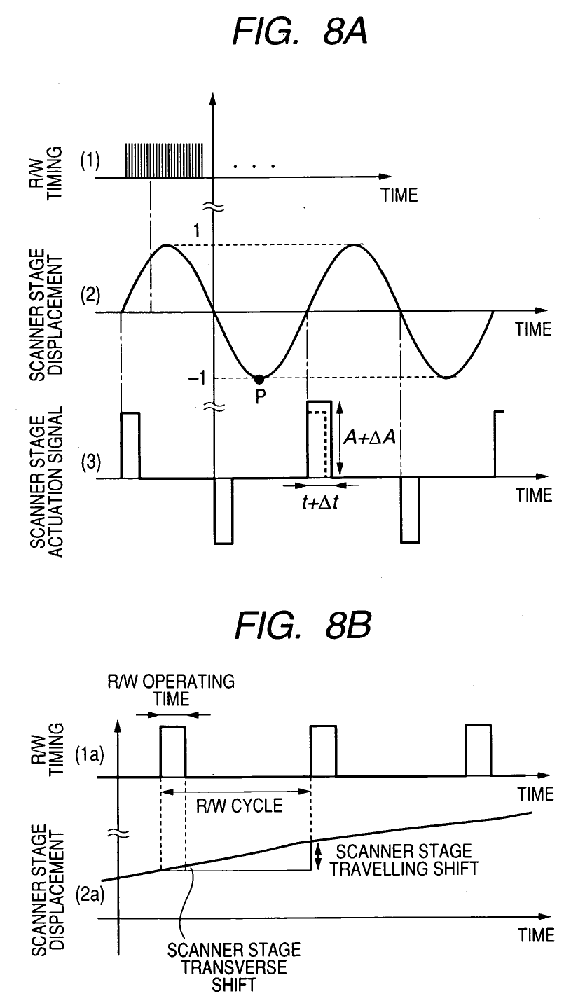

FIG. 8A illustrates a timing chart of a displacement of the stage scanner 2 and the position control signal of the X-Y electromagnetic actuator, and reading/writing of the data signal for a probe memory device according to this first embodiment. In FIG. 8A, (1) indicates a timing of reading/writing (R/W), (2) shows a time variation of relative amount of displacement with respect to a balanced position of the stage scanner 2 when there is no acting force from the driver element of the X-Y electromagnetic actuator, and (3) indicates a timing of the driving signal to the patterned coils 4.

Since the reading/writing operation is performed while accuracy of position of the probe is being kept stable for a fixed time after a reading/writing instruction was given to the control circuit of the probe memory device, it is necessary to move the stage scanner in an accurate cycle. When the stage scanner is moving, a fluid in a space e.g. air where the stage scanner is moving applies a force thereon in an inverse direction to the stage scanner movement, which will attenuate the amount of displacement gradually. Because of this, in order to compensate this attenuated portion of the kinetic energy, a driving signal is inputted into the patterned coil 4 for actuation at a timing of (3). A time-varying portion of energy retained by the X-Y electromagnetic actuator is the amount of composition of elastic energy E of the beam for supporting the stage scanner and kinetic energy K determined from the speed of the stage scanner at the time of amplitude movement. It is desirable that compensation of the kinetic energy to the stage scanner from the outside is done at a timing (3) when the elastic energy of the beam is a minimum because of small energy loss.

A point P in area (2) of FIG. 8A denotes a timing when the probe reaches a tracking area provided in the periphery of the stage scanner 2 and accuracy of position is detected. That is, it is a timing at which the stage scanner reads a preset data intrinsic to the periphery of the recording medium, detects a probing position by itself, and extracts parameters of amplitude, angular frequency, phase, etc. for correcting a position for the electromagnetic actuator. The tracking data of the stage scanner extracted at a timing P is fed back to the coil driving signal of (3) just after extraction. If necessary, the pulse width of the driving signal is corrected to t+Δt, the pulse amplitude is corrected to A+ΔA. By this step, the X-Y actuation will be made proper. By this control mechanism of a driving signal, accuracy of position of probing can always be maintained accurate.

Moreover, using FIG. 8B, a relationship between an operating time of reading/writing and the travelling shift of the stage scanner during a probing operation will be explained. The curves (1a) and (2a) are enlarged views showing (1) a reading/writing timing in FIG. 8A and (2) temporal variation of the relative amount of displacement from a balanced position of the stage scanner versus time for a very short time range. The cycle of reading/writing is determined by a reciprocal of the probing frequency. The amplitude and the angular frequency (cycle) of X-Y actuation determine a distance that the stage scanner travels during one cycle of reading/writing and a transverse shift that the stage scanner travels during a reading/writing operation.

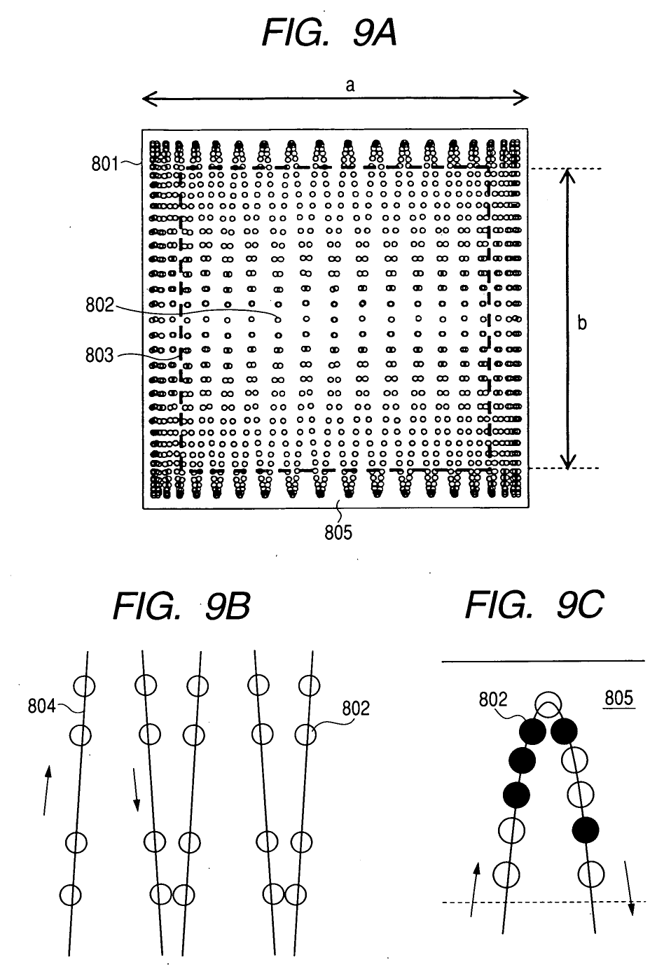

FIG. 9 is a plan view illustrating an arrangement of recording bits to/from which a certain probe tip can read/write data in the recording medium on the stage scanner according to this first embodiment. FIG. 9B is an enlarged view of an inner recording area (effective recording area 803), and FIG. 9C is an enlarged view of the periphery (tracking area 805). In FIG. 9A, symbol a designates a scanning area 801 that the probe tip can scan. In this area, as shown in FIG. 9B, recording bits 802 are arranged along a projective trajectory 804 of the probe tip by the X-Y actuation on the recording medium, each of them writes/reads information individually and properly in processing parallel with probing. In the case where the probing is done at a constant frequency, since the recording bits 802 are arranged so as to synchronize with the timing of the probing, the pitch of the recording bits 802 becomes larger when the position is nearer the inner recording area of the scanning area 801 where the travelling shift of the stage scanner per unit time is large; the pitch is small when the position is in the periphery of the scanning area 801 where the travelling shift of the stage scanner is small. This limits an effective area of the recording medium due to a formation minimum limit of the recording medium, a resolution limit of the probing by the reading/writing of data, etc.

The symbol b in FIG. 9A designates the effective recording area 803 of the information recording bits in an effective area of the recording medium located in the center of the recording medium. Note that, it is also possible to make a time required for reading/writing data constant by altering the size of the recording bit 802 in proportion to the travelling shift of the stage scanner per unit time.

The tracking area 805 used exclusively to correct position shift of the actuation of stage scanner is proved in a section of the area of the recording medium. In a parallel-processing type multi-probe memory device, data storaging is performed with one probe tip and a recording bit on the recording medium being brought to 1-to-1 correspondence. However, it is easily anticipated that position shift may occur by aging of internal mechanism parts when the device is operating. In addition to the previously stated effect by the fluid in the space surrounding the stage scanner, a pitch deviation may arise in the arrangement between the probe array chip and the recording medium due to contact between the probe tip and the recording medium and temperature rise at the time of device operation. Since high accuracy of positioning is required in the probe memory device, the shift may become a problem.

In view of this, as shown in the recording medium of FIG. 9A, for example, the tracking area 805 that is not an area b (effective recording area 803) of the information recording bit in the area a (scanning area 801) is provided in the periphery of a recording medium. Since in this tracking area 805, a pitch of the recording bits becomes too small as compared with the effective recording area 803 of the recording bits, it is not suitable as an information recording bit. Therefore, the recording bit of this tracking area 805 was made to record inherent information for position correction beforehand.

FIG. 9C shows an enlarged view of it. For example, when the recording bit (white) records “0” and the recording bit (black) records “1” reading of information with the probe tip makes it possible to detect whether the probe tip passed along its intended trajectory accurately. These pieces of information are transferred to the X-Y controller 702 upon detection. In order to correct a position shift, a method in which a Lorentz force is modulated by controlling the current to the patterned coil 4 (amplitude, angular frequency, phase, electrifying time, etc.) is conceivable.

By the above method, accurate X-Y actuation can be realized. Although in this embodiment, the drive frequency of probing was set constant, a drive frequency may be altered depending on a stage scanner position, which can in improve the recording density.

From the foregoing, by partitioning a recording medium into the information recording bit area and the potion detection area, accurate position correction can be realized effectively.

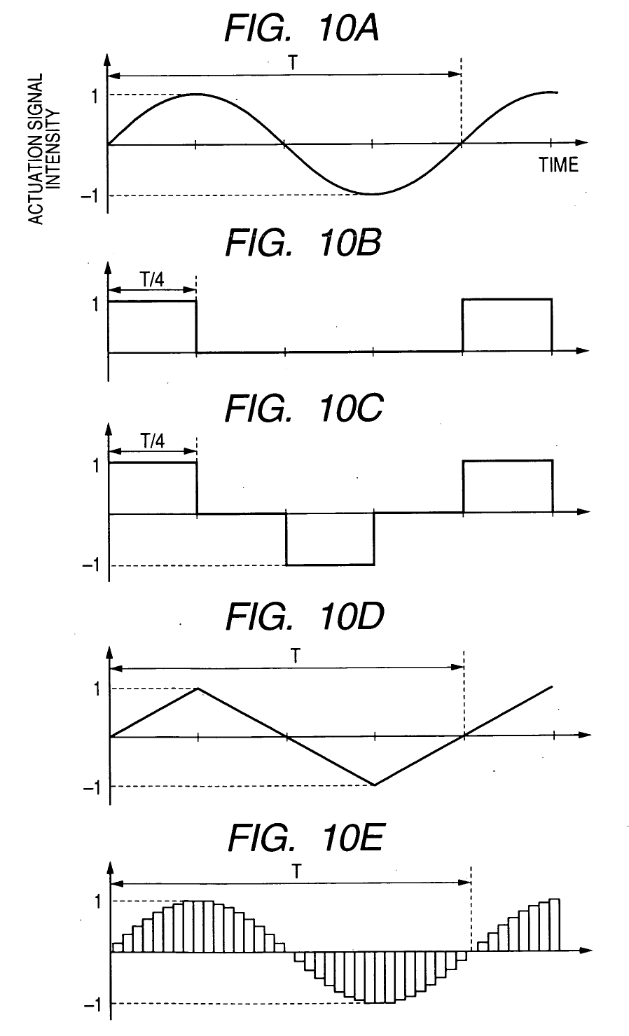

FIG. 10 shows another mode of carrying out the invention in terms of a driving signal applied to the driving patterned coil installed on the rear side of the movable stage scanner in the method of driving the X-Y electromagnetic actuator by the electromagnetic method described in this first embodiment. Since during a constant time after the reading/writing instruction was given to the control circuit of the probe memory device, a reading/writing operation is performed while accuracy of position of the probe is being kept stable, the stage scanner needs to be moved in an accurate cycle. When the stage scanner is moving, the fluid in the space e.g. air where the stage scanner is moving applies a force thereon in an inverse direction to the stage scanner movement, which will attenuate the amount of stroke gradually. In view of this, there has already been described an example in which a driving signal is applied to the patterned coil for driving with temporal variation as shown in FIG. 10C in order to compensate the attenuated portion of kinetic energy.

In order to maintain a cyclic movement of the stage scanner, for example, a sinusoidal wave as shown in FIG. 10A may be used. In this case, since a driving signal is an analog waveform, a reading/writing operation by probing can be performed while correcting a position continuously provided that the design has given a rapid response to the stage scanner.

In order to maintain a cyclic movement of the stage scanner, for example, a pulse waveform as shown in FIG. 10B may be used. In this case, since the direction of the driving signal is only one direction, it is easy to keep an output power absolute value of the driving signal constant, and stable correction of the operation can be performed.

In order to maintain a cyclic movement of the stage scanner, for example, a trianglar wave as shown in FIG. 10D may be used. In this case, in addition to an effect resulting from the use of the driving signal waveform of FIG. 10A, since correction becomes such that a variation in the driving signal is linear, loads of design and adjustment of the control circuit can be reduced.

In order to maintain a cyclic movement of the stage scanner, for example, a quantized sinusoidal wave as shown in FIG. 10E may be used. In this case, in addition to an effect resulting from the use of the driving signal waveform of FIG. 10A, since a digitized signal is handled, loads of design and adjustment of the control circuit can be reduced.

Moreover, the patterned coil may be controlled with a cyclic input waveform as illustrated by one of FIGS. 10B, 10C, 10D, and 10E.

Next, specifications of the probe memory device will be shown below, taking one with a product packager size of a 10-mm square as an example. With assumptions of a 1-mm base frame width and a 0.5-mm beam arrangement area width, the stage scanner 2 carrying the recording medium becomes a 7-mm square. An arbitrary point Q on the stage scanner when the stage scanner carrying the recording medium is stationary with no current flowing in the patterned coils 4a, 4b, 4c, and 4d is determined as an origin. By energizing the patterned coils 4a, 4b that affect driving in the X direction, an X coordinate of Point Q moves to a position X determined by
X=Ax·sin(ωx·t+φx)=Ax·sin(2πfx·t+φx).

Similarly, by energizing the patterned coils 4c, 4d that affect driving in the Y direction, an Y coordinate of Point Q moves to a position Y determined by
Y=Ay·sin(ωy·t+φy)=Ay·sin(2πfy·t+φy).

In this expression, the frequency of the X-axis component is denoted by fx, the frequency of the Y-axis component is denoted by fy, and other parameters are as described previously.

By controlling currents flowing in the patterned coils 4a, 4b, 4c, and 4d, the stage scanner is continuously moved so that a point Q on the stage scanner carrying the medium may draw a Lissajous figure such that: the amplitude Ax in the X direction and the amplitude Ay in the Y direction are both 5 μm, the oscillating frequency in the X direction is fx=0.25 Hz, the oscillating frequency in the Y direction is fy=25 Hz, and the phase φx in the X direction and the phase φy in the Y direction satisfy φx=φy+2 nπ.

The recording medium on the stage scanner of a 7-mm square is partitioned into blocks of a 10-micrometer square, and one or more probe tips are arranged to each block. A drive frequency to a Z direction of the probe is denoted by fz. By combining the stage scanner driving by the X-Y actuation and Z-driving of the probe, the probe tip is brought into contact with recording bits arranged on the recording medium mounted on the stage scanner to perform reading/writing of data. Here, the velocity V in the position (X, Y) of point Q is expressed by ((dX/dt)²+(dY/dt)²)^{(1/2)}. The velocity V in the continuous movement of the stage scanner carrying the recording medium was about 790 μm/s at maximum. A distance the stage scanner travels during one cycle (frequency fz) of the driving of Z-actuation of the probe tip, i.e., the spacing of arrangement of the recording bits on the stage scanner can be expressed as V/fz. When the Z-actuation frequency fz of the probe tip is set to 8 kHz, Z-actuation cycle of the probe tip becomes 125 μs, and during this cycle the stage scanner moves by about 100 nm at maximum. That is, the pitch of recording bits becomes 100 nm or less.

In order to move the stage scanner carrying the recording medium continuously, a positional relation between the probe tip and the recording bit will vary during when writing of data signal on the recording bit from the probe tip and reading of the data signal from the recording bit to the probe tip. Because of this, the data transfer speed required for reading/writing is set to about 1 MHz (transfer time 1 μm). With this setting, the amount of transverse shift between the probe tip and the stage scanner at the time of reading/writing can be held to the order of 1 nm.

If the minimum pitch of the recording bit in the Y direction is held to the order of 50 nm, about 72% of the stage scanner area can be made as an effective recording area for information recording, which leads to achievement of about 2.5 Gbits as a storage capacity of the probe memory device of a 10-mm square. The remaining area of the stage scanner is specified to be a position accuracy detection area.

In the actuator according to the first embodiment, by performing continuous X-Y actuation while drawing a trajectory of a Lissajous figure, a control of the patterned coil can be simplified, and it becomes possible to reduce costs of the device. Moreover, a tracking area provided in the recording medium and correction of actuation based on this can realize an accurate control of actuation. Furthermore, since there is no constraint with a damper action like a resin-made column in the conventional example, a resonance frequency when driving in the X and Y directions become high, and accordingly high-speed driving becomes possible. Since this first embodiment makes it possible to read the recording signal always with a fixed S/N ratio even when the device is operated for a long period or in an environment with a large temperature difference, a generation rate of recording error is reduced and as a result it becomes possible to improve the recording density.

In this first embodiment, an example of the input signal that continuously drives the stage scanner so that a Lissajous figure may be drawn. However, the input signal may be an input signal that suppresses a variation width of the velocity of X-Y actuation in the probing in the effective recording area, which attains improvement of the recording density.

### Second Embodiment

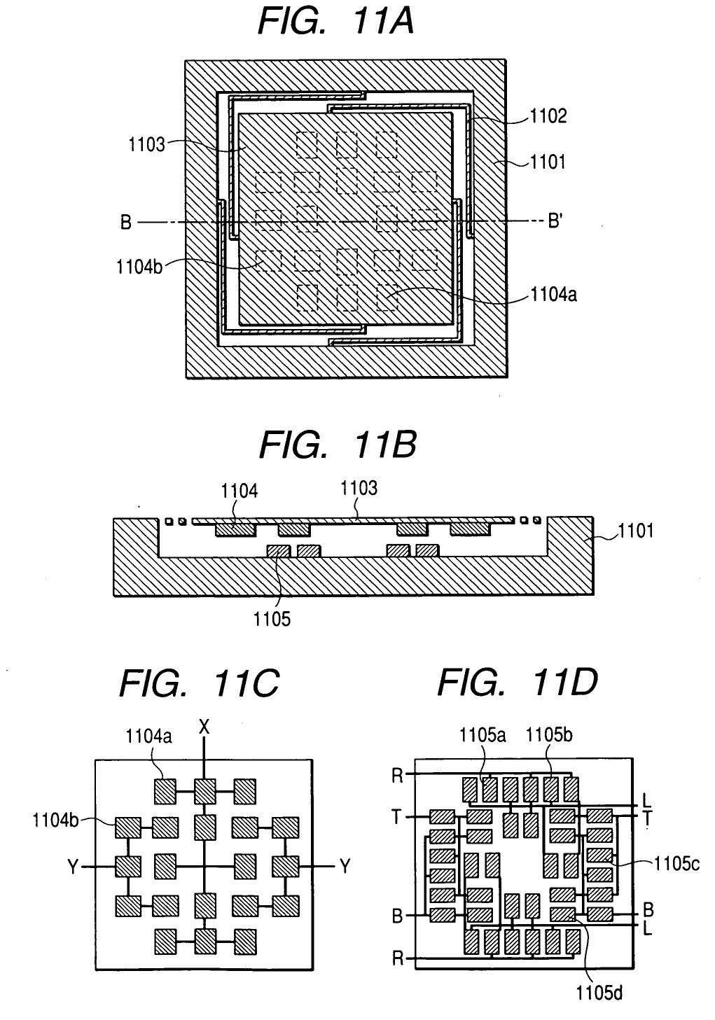

FIG. 11 shows a structure of an X-Y electrostatic actuator that drives a stage scanner carrying a recording medium in the X and Y directions independently and cyclically, as a second embodiment of this invention.

FIG. 11A is a plan view of the electrostatic actuator for driving the stage scanner carrying a recording medium in the X and Y directions. The electrostatic actuator consists of a stage scanner 1103 supported by a base frame 1101 through a beam 1102. Although not illustrated in the figure, the recording medium is mounted on the stage scanner 1103 and there exists a probe for reading/writing data signal so that it accumulates over the recording medium in the Z direction. FIG. 11B is a sectional view in the cutting plane B-B′ in FIG. 11A, showing a positional relationship between an upper electrode 1104 installed on the rear side of the stage scanner 1103 and a lower electrode 1105 installed in the base frame 1101.

The upper electrode 1104 and the lower electrode 1105 are an electrode pair that drives the stage scanner 1103 in the X and Y directions by Coulomb force, being arranged to keep a distance at which the electrode pair do not contact mutually. FIG. 11C is a plan view showing an installation side of an electrode for driving the stage scanner that is installed on the rear side of the stage scanner 1103. Here, the upper electrodes 1104 are arranged. FIG. 11D is a plan view showing an installation side of an electrode for driving the stage scanner that is installed inside the base frame 1104. Here, the fixed electrodes 1104 are arranged.

Next, a method for driving and controlling an electrostatic actuator according to this second embodiment will be described. When driving the stage scanner 1103 carrying a recording medium in the X and Y directions, the driving in the X direction is done by the upper electrode 1104a and the lower electrodes 1105a, 1105b (R/L pair), and the driving in the Y direction is done by the upper electrode 1104b and the lower electrodes 1105c, 1105d (T/B pair).

A flow of the driving method will be explained taking driving in the X direction as an example below. With the upper electrode 1104a being kept at earth potential, applying a voltage between it and the lower electrode 1105a (R) generates Coulomb attracting force between is generated. A force of an X-component of the attracting force causes the stage scanner 1103 to be moved in the R direction (right-hand side). On the other hand, with the upper electrode 1104a being kept at earth potential, applying a voltage between it and the lower electrode 1105b causes the stage scanner to be shifted in the L direction (left-hand side). Incidentally, in this second embodiment, although a driving principle of the stage scanner's X-Y actuation differs from the first embodiment, the reading/writing of a data signal, a method for detecting the accuracy of position, etc. can be realized by the same method as that of the first embodiment.

In addition to the electromagnetic driven system and the electrostatic driven system, the same probe memory device can be realized also with the piezoelectric driven system.

### Third Embodiment

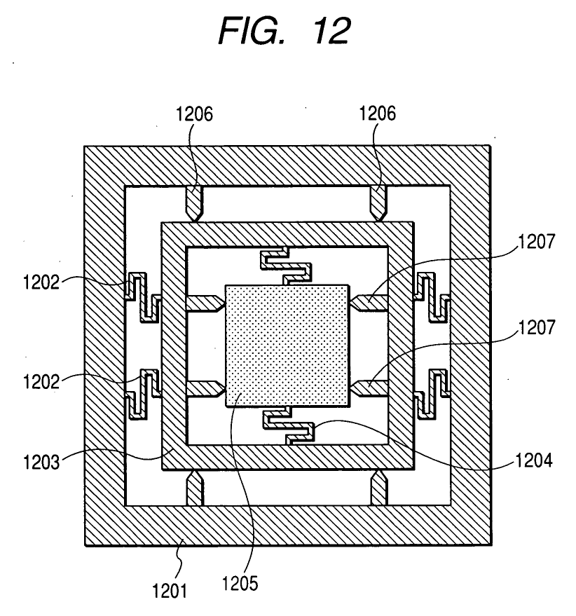

A different third embodiment of a stage scanner carrying a recording medium and a beam structure for the X-Y actuator of the probe memory device in the first and second embodiments will be described using FIG. 12.

FIG. 12 is a plan view of an actuator for driving a stage scanner in the X and Y directions in this third embodiment. The actuator according to this third embodiment consists of an inner frame 1203 supported by a base frame 1201 through a beam (X) 1202 in the X direction and a stage scanner supported by the inner frame 1203 through a beam (Y) 1204 in the Y direction.

When a stage scanner 1205 carrying a recording medium receives a driving force in the X direction by an unillustrated driving mechanism, the inner frame 1203, the beam (Y) 1204 supported in its interior, and the stage scanner 1205 are moved in the X direction as a single piece. At this time, since the beam (X) 1202 is designed to have a structure easy to expand and contract only in the X direction, the whole of the inner frame 1203 is slow to generate transverse shift in the Y direction. Simultaneously, since the beam (Y) 1204 is designed to be easy to expand and contract only in the Y direction, the stage scanner 1205 is slow to generate transverse shift in the Y direction.

Moreover, when the stage scanner 1205 carrying a recording medium receives a driving force in the Y direction by an unillustrated driving mechanism, the stage scanner 1205 moves in the Y direction. Since the beam (Y) 1204 is designed to be easy to expand and contract only in the Y direction, at this time the stage scanner is hard to generate transverse shift in the X direction. In addition, since the beam (X) 1202 is designed to have a structure easy to expand and contract only in the X direction; the inner frame 1203, the beam (Y) 1204 supported in its interior, and the whole stage scanner 1205 supported in the further interior are slow to generate transverse shift in the X direction.

In the case where the X-Y actuation of the stage scanner is a continuous moving system that is not accompanied with halt control as described in the first embodiment and is a moving system such that an arbitrary point on the stage scanner draws a trajectory of a Lissajous figure on an X-Y plane, movement cycles of the stage scanner in the X direction and in the Y direction are driven and controlled independently. Therefore, it is possible to design a structure such that the natural frequency of the stage scanner is different between in the X direction and in the Y direction, which increases a design freedom of the stage scanner and the beam.

For example, as in the third embodiment, by changing the number of the beams (X) 1202 supporting the stage scanner in the X direction and the number of the beams (Y) 1204 supporting the stage scanner in the Y direction, the stage scanner can be designed so that a mechanical natural frequency of the stage scanner may differ between in the X direction and in the Y direction.

In addition, although not illustrated in the figure, the number of folding of the beam supporting the stage scanner is changed between in the beam (X) and in the beam (Y), so that the stage scanner may be configured to have different spring constant between when the stage scanner moves in the X direction and when doing in the Y direction. Therefore, the stage scanner can be designed to have different mechanical natural frequencies between in the X direction and in the Y direction.

Although not illustrated in the figure, the stage scanner can be designed to have a structure in which the length of the beam of the beam supporting the stage scanner is altered between the beam (X) and the beam (Y), and thereby a mechanical natural frequency is made different between the X direction and the Y direction. In addition, by a combination of the methods described just above, the stage scanner can be designed to have mechanical natural frequencies thereof different in the X direction and in the Y direction.

Addition of guide pillars (X) 1206 for guiding a moving direction of the inner frame 1203 to the X direction and guide pillars (Y) 1207 for guiding a moving direction of the inner base frame to the Y direction to this structure brings about an effect of preventing the moving direction of the stage scanner carrying the recording medium from deviating largely from the X direction or Y direction. As an example of a guide pillar, one end of the guide pillar is fixed to the frame of the outer framework and the other end of the guide pillar is brought closer to the actuation member and moved to the actuation member slidably, whereby the above-mentioned effect can be attained.

### Fourth Embodiment

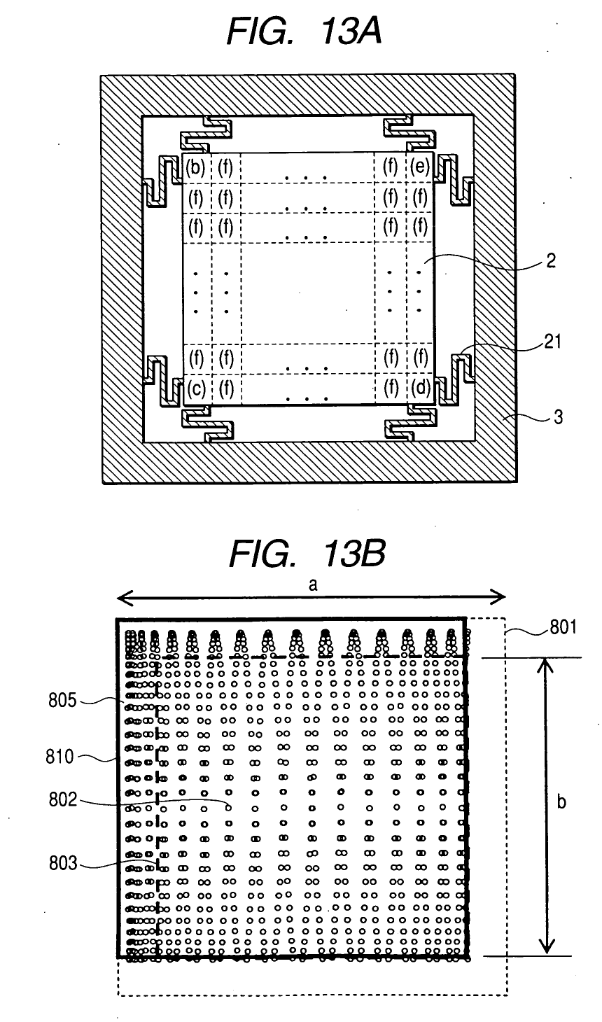

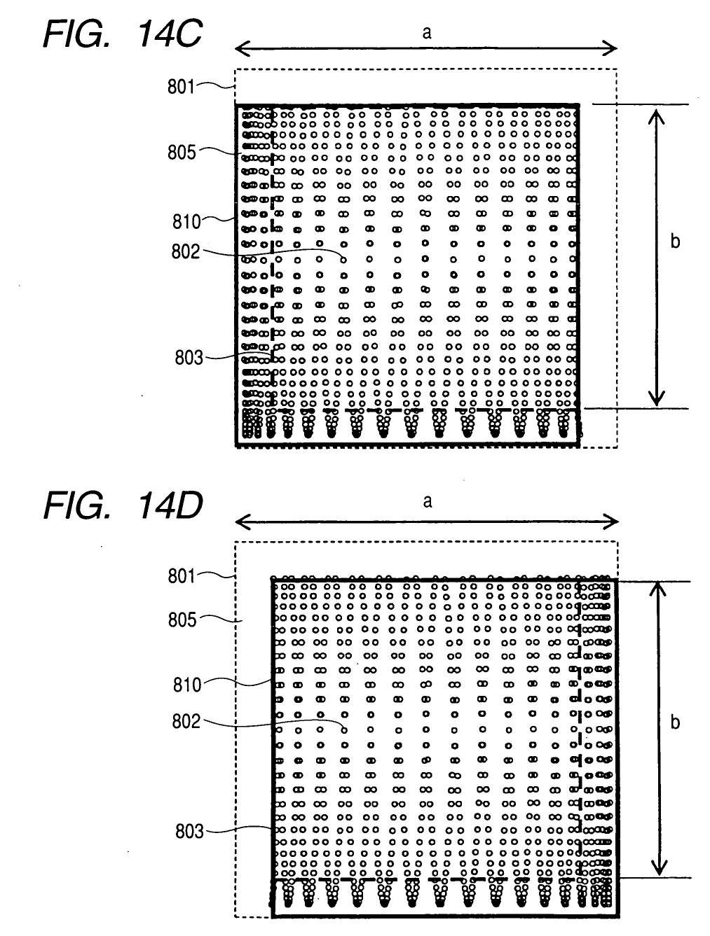

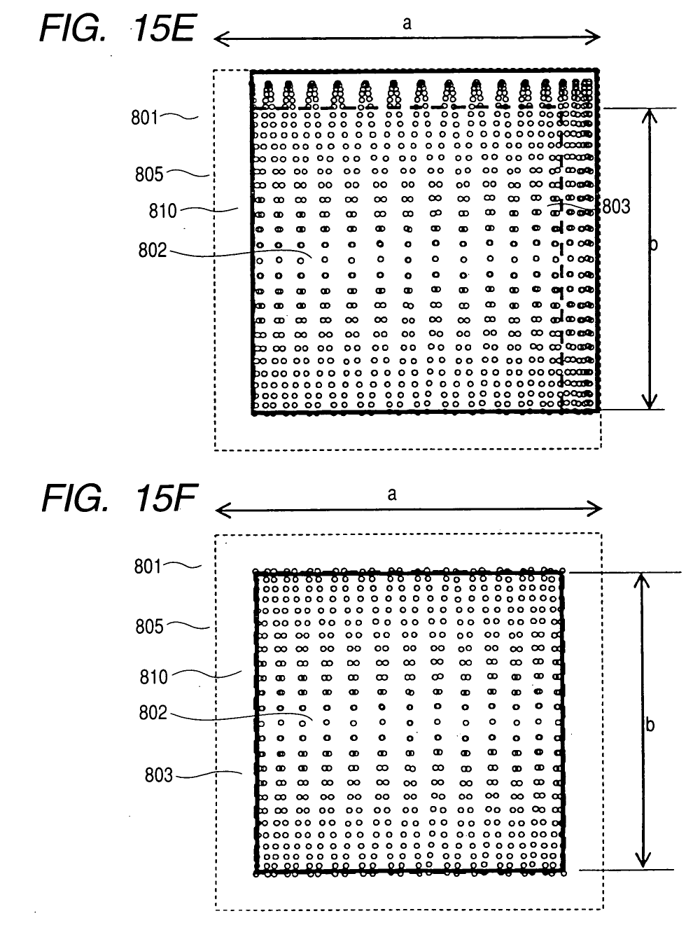

Another fourth embodiment regarding an arrangement of the recording bits on the stage scanner carrying a recording medium of the probe memory device in the first, second, and third embodiments and a method for driving a probe on which a probe tip is provided along the Z-axis will be described using FIGS. 13-15. FIG. 13A a view schematically showing an arrangement of the recording bits in the stage scanner 2 carrying the recording medium of the actuator. FIG. 13B shows an arrangement of the recording bits in the effective recording area (b) located at a vertex of the stage scanner. The probe tip that scans the effective recording area (b) by the actuation of the stage scanner 2 carrying the recording medium is assumed to move within a square scanning area with one side a, just as the example shown in FIG. 9. The recording bits are arranged along the trajectory made by scanning of the probe tip both in the tracking area 805 that adjoins two sides including vertexes of the stage scanner carrying the recording medium and in the effective recording area 803 of one side a that is an inner recording area of the scanning area 801. Similarly for the effective recording areas (c), (d), and (e) each located at other vertex of the stage scanner 2 carrying the recording medium, the recording bits shown in FIGS. 14C, 14D, and FIG. 15E shall be arranged.

In comparison to this, FIG. 15F shows an arrangement of the recording bits 802 only in the effective recording area 803 that is the inner recording area of the scanning area 801 of the probe tip. In (f) in FIG. 13A, the effective recording area 803 in FIG. 15F is arranged to contact the above-mentioned areas (b), (c), (d), and (e) in the effective recording area 803.

For the effective recording areas (b), (c), (d), (e), and (f) formed on the stage scanner 2 carrying the recording medium, the recording medium shall have a configuration in which the recording bits are placed along a trajectory of the probe tips by arranging the probe tips in the form of an array so as to make one-to-one correspondence with a pitch b.

Next, the probing to the recording bit with the probe tip will be explained. By the actuation of the stage scanner 2 carrying the recording medium, each probe tip scans the scanning area 801 corresponding to this on the stage scanner 2 carrying the recording medium. For the effective recording areas (b), (c), (d), and (e), when the probe tip exists in the effective recording area 803 and the tracking area 805 in the scanning area 801, the probe tip is made to translate at a constant frequency in the Z direction in synchronization with the X-Y actuation of the stage scanner 2 carrying the recording medium. For the effective recording area (f), when the probe tip exists in the effective recording area 803 in the scanning area 801, the probe tip is made to perform the same operations.

By the translation, the probe tip is brought into contact with or closer to the recording bit 802. Writing or reading of a data is performed by the contact or the proximity of the probe tip to the recording bit 802 in the effective recording area 803.

Moreover, by the probe tip contact being brought into contact with or closer to the recording bit 802 in the tracking area 805, recorded information is read. By this reading, relative position information between the stage scanner 2 carrying a recording medium and the probe tip is recognized accurately, and correction of the actuation is performed based on this.

On the other hand, driving of the Z actuator is controlled so that probing will not be done when the probe tip exists in the scanning area 801 of scanning by the probe tip except for both the effective recording area 803 and the tracking area 805.

In the probe memory device according to the fourth embodiment, effective arrangement of the information recording bits and addition of a simple control signal for probing made it possible to increase the area of recording medium for information recording in the stage scanner carrying the recording medium and arrange the recording bits densely, thereby being able to increase the recording capacity of a product package. As compared with the 10-mm square product package described in the first embodiment, the recording device of double or more storage capacity was able to be manufactured.

In this fourth embodiment, the example in which the tracking areas were provided in the vicinities of four vertexes of the stage scanner 2 carrying the medium. However, this invention is not restricted to this, and the tracking area may be provided only in the vicinity of a certain vertex, or along a side of the stage scanner 2 carrying the medium.

### Fifth Embodiment

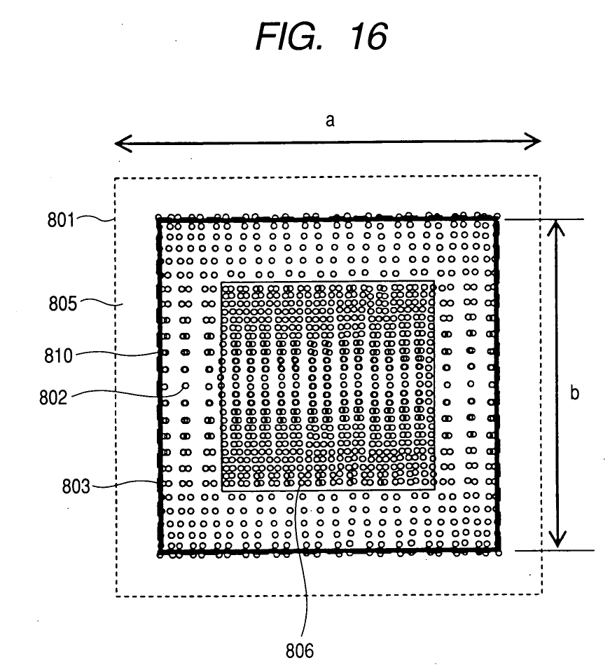

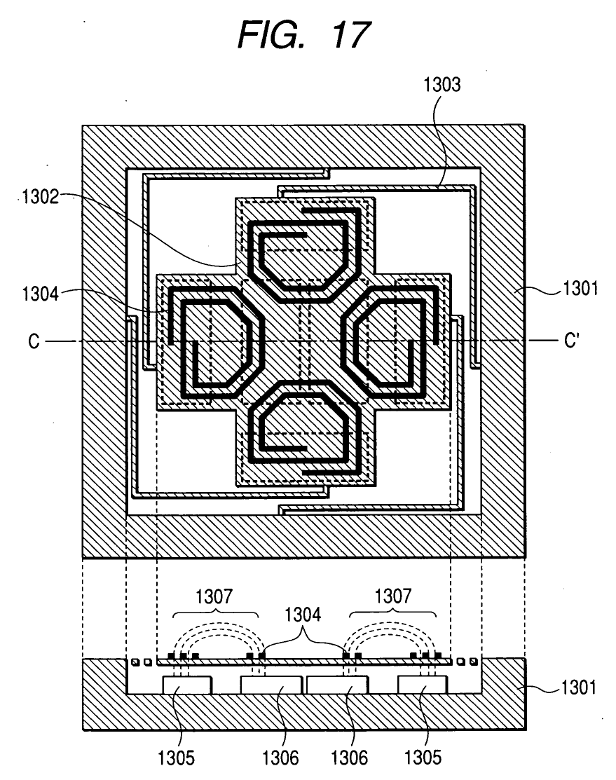

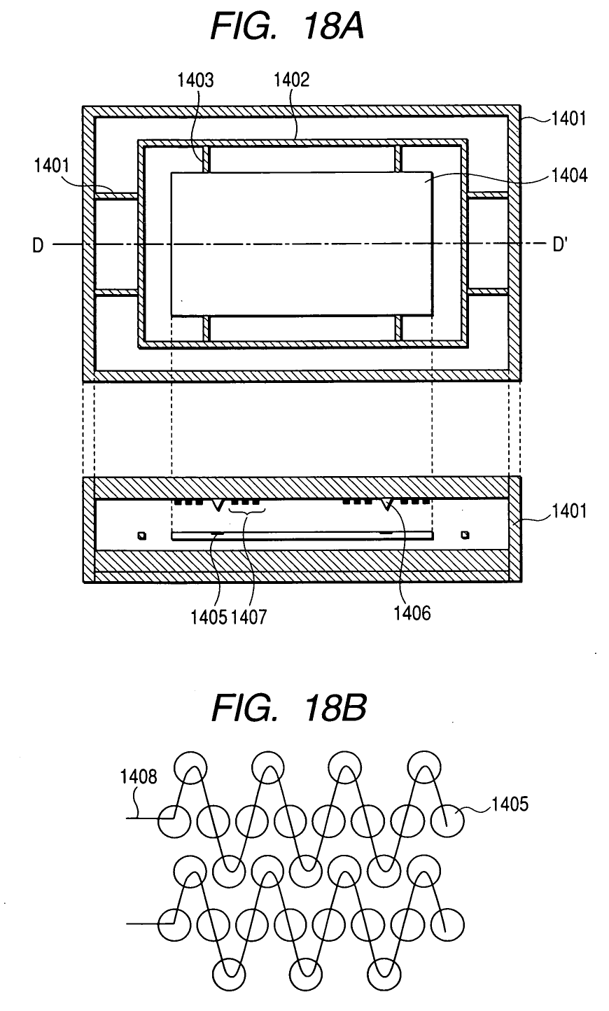

This fifth embodiment is an example showing a mode for carrying out the invention in which the density of the recording bits of the recording medium section is increased by varying a driving frequency in the Z direction in synchronization with the X-Y actuation of the stage scanner carrying a recording medium in the first, second, third, and fourth embodiments. Here, a method for increasing the density will be explained using FIG. 16, taking a method for disposing the recording medium in a scanning area of the probe memory device described in the fourth embodiment and driving the Z actuator as an example.

FIG. 16 is a view schematically showing an arrangement of the recording bits in the effective recording area (f) on the stage scanner 2 carrying the recording medium described in the fourth embodiment. In the scanning area 801 of one side a that the probe tip scans, the frequency of probing in the effective recording area 803 is controlled to be two ways: the frequency of an inner recording area 806 of the effective recording area 803 shall be higher than that of other area of the effective recording area 803. By this control, the probing interval in the inner recording area 806 is made small. By arranging the recording bits of the recording medium section correspondingly to positions of probing, the recording density of the central region of the recording medium section where the recording density was low in the embodiments shown previously was able to be increased.

For example, in the case where a probing frequency is increased by a factor of 1.5 for 25% of the scanning area 801, as compared with the 10-mm square product package described in the fourth embodiment, a recording device with a 1.5 times or more the recording capacity was able to be manufactured by effective arrangement of the information recording bits and addition of a simple control signal for probing.

Although in this fifth embodiment, the effective recording area 803 was partitioned into two and probing frequencies of two specifications were controlled, the partition is not restricted to this. The probing frequency may be controlled in multi-stages with respect to X-Y actuation of the stage scanner or may be varied continuously. It is desirable in terms of improvement of the recording density that the recording bits are arranged in the probe array chip in synchronization with the interval of probing. In addition, by specifying the recording bits as element for detecting tracking data described in the embodiments, the probe array chip also brings about an effect of attaining further improvement of accuracy of position.

In the foregoing, the invention made by the inventors was explained concretely based on its embodiments. Naturally, this invention is not restricted to the above-mentioned embodiments, but it is obvious that various modifications are possible without departing from the scope of the invention.

This probe memory device according to this invention can provide a high-density recording device at low costs by simplifying controls of X-Y actuation and probing. Moreover, an accurate positioning mechanism was able to be built into the device without increasing manufacturing costs, and accordingly reliability of the device was able to be increased. Furthermore, arranging probes into an array makes it possible to provide a recording device with a fast operating speed.

This invention makes it possible to provide a recording device that can storage recording capacity that surpasses that of the current semiconductor memory device in a volume smaller than that of the magnetic disk. It is a technique that is expected to attain higher density up to a recording density surpassing the magnetic disk in the future, and accordingly has a high usefulness, as an alternative product for the magnetic disk, as an external storage device of a server needing a large scale recording system, and as a recording device of a small-size portable terminal.

This invention can be utilized in production industries of electronic equipment and the like.

What is claimed is:

1. A probe memory device that writes or reads information by bringing a probe tip closer to or into contact with a recording medium, comprising:
a probe array chip in which a plurality of probes each containing the probe tip are arranged;
the recording medium supported by a high-stiffness elastic support structure so as to maintain an almost constant spacing to the probe array chip;
a stage scanner that actuates the recording medium continuously while drawing a constant trajectory on an X-Y plane almost parallel to a probe array chip plane; and
an actuator that actuates each of the probe tips in a Z direction almost perpendicular to the X-Y plane; wherein
a distance between the probe tip and the recording medium is altered by the actuator in parallel processing, whereby information is recorded or read.

2. The probe memory device according to claim 1, wherein
the recording medium has a plurality of information recording bits for storing information, and
an area on which the probe tips scan on the recording medium is wider than an area where the information recording bits are arranged.

3. The probe memory device according to claim 2, wherein
the recording medium has an area in which a position detecting element is placed in the periphery of the area where the information recording bits are arranged, and
an arrangement interval of the position detecting elements is narrower than an arrangement interval of the information recording bits.

4. The probe memory device according to claim 2, wherein
an interval at which the information recording bits are arranged is not an equal interval.

5. The probe memory device according to claim 1, wherein
a drawn trajectory is a Lissajous figure.

6. The probe memory device according to claim 1, wherein
the stage scanner is driven by an electrostatic actuation mechanism, an electromagnetic actuation mechanism, or a piezoelectric actuation mechanism.

7. The probe memory device according to claim 1, further comprising
means for, when a velocity at which the probe tip scan the recording medium is slow, correcting a position of the stage scanner.

8. The probe memory device according to claim 1,
the recording medium having an area in which position detecting elements are arranged, further comprising
a correction and control mechanism that detects a deviation of the trajectory of the stage scanner by reading a position signal of the position detecting element by the probing with the probe and correcting the deviation based on the result.

9. A positioning method for a probe memory device that records or reads information by bringing a probe tip closer to or into contact with the recording medium, wherein
the probe tip scans the recording medium, and when its scanning velocity is slow, a position of a trajectory of X-Y actuation for actuating the recording medium is corrected.

10. A positioning method for a probe memory device that records or reads information by making a probe tip come close to or contact with a recording medium, wherein
a correction data area exclusive for a positioning signal is provided in the periphery of the recording medium, and
the positioning signal is read by probing with the probe tip, whereby a deviation of the trajectory of X-Y actuation for driving the recording medium is detected and corrected.
